(19) United States
(12) Patent Application Publication
(10) Pub. No.: US 2024/0405577 A1
(43) Pub. Date: Dec. 5, 2024

(54) BATTERY SYSTEM

(71) Applicant: Prime Planet Energy & Solutions, Inc., Tokyo (JP)

(72) Inventor: Junya YANO, Kato-shi (JP)

(21) Appl. No.: 18/668,250

(22) Filed: May 20, 2024

(30) Foreign Application Priority Data
May 29, 2023 (JP) 2023-087475

(51) Int. Cl. H02J 7/00

(52) U.S. Cl. CPC H02J 7/0019; H02J 7/0025; H02J 7/0045; H02J 7/0047; H02J 7/0063; H02J 7/007182

(57) ABSTRACT

A battery system includes: a pair of output terminals connected to a load; battery modules connected to the output terminals and disposed in parallel to each other; and a controller. Each of the battery modules includes: a battery unit including cells connected in series to each other; a main relay provided on a first side end portion of the battery unit; a unit relay provided on a second side end portion of the battery unit; and a pre-charging unit provided in parallel to the main relay. The controller includes a pre-charging process executor configured or programmed to, when the battery modules are to be connected to the load, exercise control so as to connect the battery modules to the pair of output terminals after having executed a pre-charging process on the battery modules on a one-by-one basis.

### CROSS REFERENCE TO RELATED APPLICATIONS

The application claims the benefit of priority to Japanese Patent Application No. 2023-087475 filed on May 29, 2023. The entire contents of this application are incorporated herein by reference.

### BACKGROUND OF THE DISCLOSURE

### 1. Field

The present disclosure relates to battery systems.

### 2. Background

WO 2012/043723, for example, discloses a power supply apparatus including battery units connected in parallel to each other. The battery units each include battery blocks connected in series to each other. A pre-connection circuit is provided for each of the battery units. The pre-connection circuits each include a current limiting resistor and an equalizing switch connected in series to the current limiting resistor. When the power supply apparatus is connected to a load, passage of currents through the pre-connection circuits connected to the battery units equalizes the remaining capacities of the battery units.

JP 2005-151679 A, for example, discloses a method for adjusting a voltage across a battery pack including parallel-connected modules each including cells connected in series to each other. A resistor is connected in series to each of the modules. Because the modules are connected in parallel to each other, current(s) flow(s) from the module(s) whose remaining capacity(ies) is/are large to the module(s) whose remaining capacity(ies) is/are small. This gradually uniformizes the remaining capacities of the modules, making it possible to adjust the voltage across the battery pack.

Japanese Patent No. 7136424, for example, discloses a turn-on operation control apparatus including battery packs connected in parallel to each other. Each of the battery packs is provided with: battery cells connected in series to each other; and a switch section connected in series to the battery cells. Before charging or discharging starts, the wattage energy integrated value of each battery pack is calculated, and the order in which the switch sections of the battery packs are to be turned on is decided such that the switch sections of the battery packs will be turned on in descending order of their wattage energy integrated values.

When currents are passed through the pre-connection circuits connected to the battery units of the power supply apparatus disclosed in WO 2012/043723, for example, the consumption of current by a controller to control the equalizing switches and/or other components may vary greatly. If the current consumption varies greatly, a load may be applied to a power supply that supplies electric power to the controller, which may result in voltage variations and may thus cause the power supply apparatus to operate unstably. Accordingly, variations in the current consumption are preferably reduced as much as possible.

### SUMMARY

A battery system according to an embodiment of the present disclosure includes: a pair of output terminals connected to a load; battery modules connected to the pair of output terminals and disposed in parallel to each other; and a controller. Each of the battery modules includes: a battery unit including cells connected in series to each other; a main relay provided on a first side end portion of the battery unit; a unit relay provided on a second side end portion of the battery unit; and a pre-charging unit provided in parallel to the main relay. The pre-charging unit of each of the battery modules includes: a pre-resistor; and a pre-charging relay connected in series to the pre-resistor. The controller includes a pre-charging process executor configured or programmed to, when the battery modules are to be connected to the load through the pair of output terminals, exercise control so as to connect the battery modules to the pair of output terminals after having executed a pre-charging process on the battery modules on a one-by-one basis. The pre-charging process involves switching OFF the main relay of a targeted one of the battery modules and switching ON the unit relay and the pre-charging relay of the targeted one of the battery modules, and the pre-charging process then involves switching ON the main relay of the targeted one of the battery modules and switching OFF the pre-charging relay of the targeted one of the battery modules when a difference between a main voltage carried between the pair of output terminals and a unit voltage across the battery unit of the targeted one of the battery modules is equal to or smaller than a predetermined threshold value.

If the pre-charging relays of the battery modules are switched ON simultaneously, the consumption of current necessary for controlling the pre-charging relays increases temporarily, resulting in great variations in the consumption of current by the controller to control the pre-charging relays. Such great variations in the consumption of current by the controller, for example, may apply a load to a power supply that supplies electric power to the controller and may lead to variations in voltage across the power supply. Thus, great variations in voltage across the power supply, which supplies electric power to the controller, may cause the battery system to operate unstably. The battery system according to the embodiment of the present disclosure, however, involves performing the pre-charging process on the battery modules sequentially on a one-by-one basis. Accordingly, the embodiment of the present disclosure precludes the pre-charging relays of the battery modules from being switched ON simultaneously, making it possible to stagger the time at which the consumption of current by the controller to control the pre-charging relays of the battery modules increases. Consequently, the embodiment of the present disclosure is able to reduce variations in overall current consumption by the controller, making the battery system unlikely to operate unstably.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating a battery system according to an embodiment of the present disclosure.

FIG. 2 is a flow chart illustrating a procedure for performing a pre-charging process on first to third battery modules.

FIG. 3 is a timing chart illustrating the procedure for performing the pre-charging process on the first to third battery modules.

FIG. 4 is a graph illustrating how voltages across the battery modules change with the lapse of time when the pre-charging process is performed on the first to third battery modules simultaneously.

FIG. 5 is a graph illustrating how voltages across the battery modules change with the lapse of time when the pre-charging process is performed on the first to third battery modules sequentially.

### DETAILED DESCRIPTION

An embodiment of the present disclosure will be described below with reference to the drawings. The embodiment described below is naturally not intended to limit the present disclosure in any way. Each of the drawings is a schematic diagram, chart, or graph and thus does not faithfully reflect actual products provided by implementation of the present disclosure. Components and elements having the same functions will be identified by the same reference signs and will be described briefly or will not be described when deemed redundant.

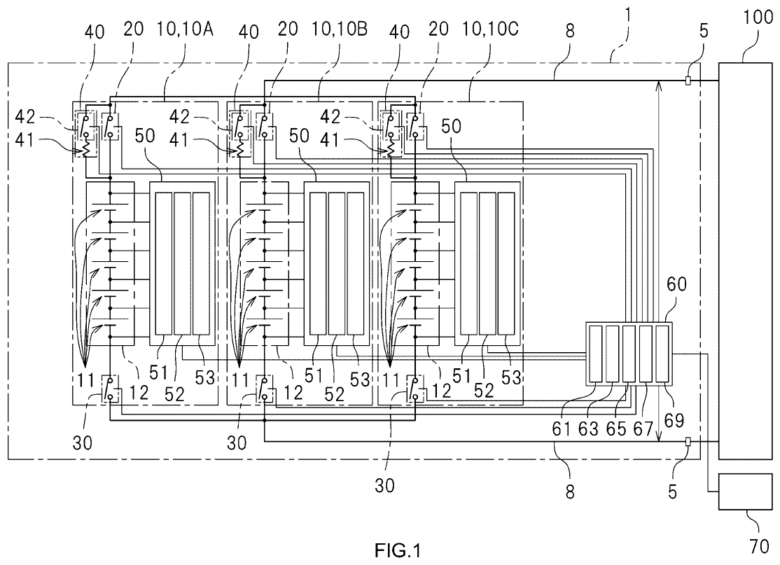

FIG. 1 is a schematic diagram illustrating a battery system 1 according to the present embodiment. As illustrated in FIG. 1, the battery system 1 is connected to a load 100. The load 100 may be any suitable load. The load 100 is, for example, a driving device (such as an electric motor for a vehicle) or an inverter. A smoothing capacitor to reduce sudden current changes may be connected to the load 100. In this embodiment, the battery system 1 is installed on a vehicle (e.g., a hybrid electric vehicle, a plug-in hybrid electric vehicle or a battery electric vehicle) and used as a power supply to supply electric power to an electric motor that causes the vehicle to run. The battery system 1, however, does not necessarily have to be used for a vehicle.

The battery system 1 includes a pair of output terminals 5, battery modules 10, and a controller 60. The pair of output terminals 5 is connected to the load 100. In this embodiment, one of the output terminals 5 is a positive electrode terminal, and the other output terminal 5 is a negative electrode terminal.

The battery modules 10 are connected to the pair of output terminals 5. In the present embodiment, the battery modules 10 are connected to main buses 8, and the main buses 8 are connected with the pair of output terminals 5. The battery modules 10 are thus connected to the pair of output terminals 5 through the main buses 8. The battery modules 10 are indirectly connected to the load 100 through the pair of output terminals 5. The load 100 may be able to convert electric power generated by the battery modules 10 into motive power and/or supply regenerated electric power to the battery modules 10. The battery modules 10 are arranged in parallel to each other (i.e., connected in parallel to each other). The battery system 1 may include any suitable number of battery modules 10. In the present embodiment, the number of battery modules 10 is three. The battery modules 10 include a first battery module 10A, a second battery module 10B, and a third battery module 10C. The three battery modules 10 may be referred to as the “first to third battery modules 10A to 10C” when appropriate. In the following description, the term “battery modules 10” will be used when the description is common to the first to third battery modules 10A to 10C.

In the present embodiment, the first to third battery modules 10A to 10C are similar in structure, configuration, or arrangement. Each of the battery modules 10 includes cells 11, a main relay 20, a unit relay 30, a pre-charging unit 40, and a battery controller 50. The cells 11 are chargeable and dischargeable. Examples of batteries usable as the cells 11 may include secondary batteries, each of which is repeatedly chargeable and dischargeable by movement of charge carriers between a pair of electrodes (e.g., positive and negative electrodes) through an electrolyte. Secondary batteries, such as lithium ion secondary batteries or nickel-metal hydride batteries, may be used as the cells 11. The cells 11 of each battery module 10 are connected in series to each other. In this embodiment, the cells 11 of each battery module 10 are connected in series to each other through a bus bar (not illustrated). Each of the battery modules 10 may include any suitable number of cells 11. Each of the battery modules 10 may include a predetermined number of cells 11. In the present embodiment, the number of cells 11 included in each of the battery modules 10 is five. Although the first to third battery modules 10A to 10C include equal numbers of cells 11 in the present embodiment, the first to third battery modules 10A to 10C may alternatively include different numbers of cells 11. The cells 11 of each battery module 10 connected in series to each other may hereinafter be referred to as a “battery unit 12”. In other words, each battery unit 12 includes the cells 11 connected in series to each other.

In each battery module 10, the main relay 20 is connected in series to the cells 11 (i.e., the battery unit 12). In each battery module 10, the main relay 20 is provided on a first side end portion of the battery unit 12. As used herein, the term “first side end portion” refers to a positive electrode side end portion of each battery unit 12 (i.e., the cells 11 included therein). Alternatively, the term “first side end portion” may refer to a negative electrode side end portion of each battery unit 12. In other words, each main relay 20 may be provided on the negative electrode side end portion of the associated battery unit 12. Each main relay 20 is switched ON and OFF so as to connect and disconnect the first side end portion of the associated battery unit 12 to and from the load 100.

In the present embodiment, a relay that is switched ON is in a connected state (e.g., a closed state), and a relay that is switched OFF is in a disconnected state (e.g., an open state).

In each battery module 10, the unit relay 30 is connected in series to the cells 11 (i.e., the battery unit 12). In each battery module 10, the unit relay 30 is provided on a second side end portion of the battery unit 12. As used herein, the term “second side end portion” refers to an end portion of each battery unit 12 (i.e., the cells 11 included therein) opposite to the first side end portion thereof. In this embodiment, the term “second side end portion” refers to the negative electrode side end portion of each battery unit 12. Alternatively, the term “second side end portion” may refer to the positive electrode side end portion of each battery unit 12. In other words, each unit relay 30 may be provided on the positive electrode side end portion of the associated battery unit 12. Each unit relay 30 is switched ON and OFF so as to connect and disconnect the second side end portion of the associated battery unit 12 to and from the load 100.

In each battery module 10, the pre-charging unit 40 is provided in parallel to the main relay 20. In other words, the pre-charging unit 40 is connected in parallel to the main relay 20 in each battery module 10. In each battery module 10, the pre-charging unit 40 is provided on the first side end portion (which is, in this embodiment, the positive electrode side end portion) of the battery unit 12 (e.g., the series-connected cells 11 included therein). Each pre-charging unit 40 is a circuit to prevent a rush current from flowing to the load 100 during supply of electric power from the battery system 1 to the load 100. Each pre-charging unit 40 is not limited to any particular structure, configuration, or arrangement. In this embodiment, each pre-charging unit 40 includes a pre-resistor 41 and a pre-charging relay 42 connected in series to the pre-resistor 41. Each pre-charging relay 42 is switched ON and OFF so as to connect and disconnect the first side end portion of the associated battery unit 12 to and from the load 100.

In each battery module 10, the battery controller 50 is connected to the cells 11. Each battery controller 50 includes a substrate and is provided with a “register”. Each battery controller 50 may be, for example, a microcontroller. Each battery controller 50 includes a cell voltage detector 51, an equalizer 52, and a battery unit voltage detector 53.

Each cell voltage detector 51 detects cell voltages across the cells 11 included in the associated battery unit 12. Each cell voltage detector 51 is implemented by, for example, a circuit that is able to detect voltages across the cells 11. Each cell voltage detector 51 may include, for example, connection terminals connected to positive and negative electrodes of the cells 11 included in the associated battery unit 12.

Each equalizer 52 equalizes the remaining capacities of the cells 11 included in the associated battery unit 12 in accordance with the cell voltages across the cells 11 detected by the associated cell voltage detector 51. Each equalizer 52 may be any equalizer that is able to equalize the remaining capacities of the associated cells 11. Each equalizer 52 may be implemented by an “equalizing circuit”. Although not illustrated, each equalizer 52 may be implemented by, for example, discharging circuits (which are connected between the connection terminals connected to the positive and negative electrodes of the associated cells 11) and a control circuit. The discharging circuits of each equalizer 52 each include a discharging resistor and a switching element. The control circuit of each equalizer 52 is configured or programmed to be able to acquire the cell voltages across the cells 11 from the associated cell voltage detector 51. The control circuit of each equalizer 52 acquires the cell voltages across the cells 11 from the associated cell voltage detector 51, for example, through a multiplexer (not illustrated). The control circuit of each equalizer 52 is configured or programmed to, in accordance with the cell voltages acquired, allow selection between ON and OFF of the switching element so as to suitably perform a discharging process such that the cell voltage(s) across the cell(s) 11 high in voltage is/are adjusted to the cell voltage(s) across the cell(s) 11 low in voltage.

In each battery module 10, the battery unit voltage detector 53 detects a unit voltage across the battery unit 12 including the cells 11 connected in series to each other. Each battery unit voltage detector 53 is implemented by, for example, a circuit that is able to detect the unit voltage across the associated battery unit 12. Each battery unit voltage detector 53 includes connection terminals connected to the positive and negative electrodes of the cells 11 included in the associated battery unit 12. Each battery unit voltage detector 53 may detect the unit voltage across the associated battery unit 12 by, for example, summing the cell voltages across the cells 11 detected by the associated cell voltage detector 51.

The controller 60 is, for example, a microcontroller. The controller 60 includes: a communication interface; a central processing unit (CPU) to execute commands included in a control program; a read-only memory (ROM) storing the program to be executed by the CPU; a random-access memory (RAM) used as a working area where the program is to be decompressed; and a storage device (such as a memory) storing the program and various data. The controller 60 is electrically connected to the main relays 20, the unit relays 30, the pre-charging relays 42 (which are included in the pre-charging units 40), and the battery controllers 50 of the battery modules 10 (i.e., the first to third battery modules 10A to 10C in this embodiment). The controller 60 controls switching ON and OFF of the main relay 20, the unit relay 30, and the pre-charging relay 42 of each of the battery modules 10. As illustrated in FIG. 1, the controller 60 in the present embodiment is connected with a power supply 70. The controller 60 receives electric power from the power supply 70.

As illustrated in FIG. 1, the controller 60 in the present embodiment includes a main voltage acquirer 61, a unit voltage acquirer 63, an order decider 65, a pre-charging process executor 67, and a memory 69. The main voltage acquirer 61, the unit voltage acquirer 63, the order decider 65, the pre-charging process executor 67, and the memory 69 may each be implemented by a single or more than one processor or may each be implemented by a circuit.

The main voltage acquirer 61 acquires a main voltage across all of the parallel-connected battery modules 10. To put it another way, the main voltage acquirer 61 acquires the main voltage carried between the pair of output terminals 5. Or to put it still another way, the main voltage acquirer 61 acquires the main voltage between the main buses 8. The main voltage acquirer 61 may be any main voltage acquirer that is able to acquire the main voltage. The main voltage acquirer 61 may be implemented by, for example, a circuit that is able to detect the main voltage between the pair of output terminals 5. The main voltage acquirer 61 may be provided with, for example, connection terminals connected to the positive electrode side main bus 8 and the negative electrode side main bus 8 (or to the pair of output terminals 5).

The unit voltage acquirer 63 acquires the unit voltage across the battery unit 12 of each of the battery modules 10. In this embodiment, the unit voltage acquirer 63 acquires the unit voltage across each of the first to third battery modules 10A to 10C. In the present embodiment, the unit voltage acquirer 63 acquires the unit voltages from the battery unit voltage detectors 53 of the battery controllers 50 of the battery modules 10. In this embodiment, the battery unit voltage detectors 53 detect the unit voltages across the battery units 12 and transmit the detected unit voltages to the controller 60. The unit voltage acquirer 63 acquires the unit voltages across the battery units 12 by receiving the unit voltages transmitted from the battery unit voltage detectors 53.

The pre-charging process executor 67 executes a pre-charging process on each of the battery modules 10 when the battery modules 10 are connected to the load 100 through the pair of output terminals 5. The pre-charging process executor 67 executes the pre-charging process on the battery modules 10 on a one-by-one basis. In the present embodiment, the pre-charging process executor 67 executes the pre-charging process on the first battery module 10A, the second battery module 10B, and the third battery module 10C separately. In one example, the pre-charging process executor 67 executes the pre-charging process on the first battery module 10A, and then executes the pre-charging process on the second battery module 10B after having finished the pre-charging process on the first battery module 10A. The pre-charging process executor 67 subsequently executes the pre-charging process on the third battery module 10C after having finished the pre-charging process on the second battery module 10B.

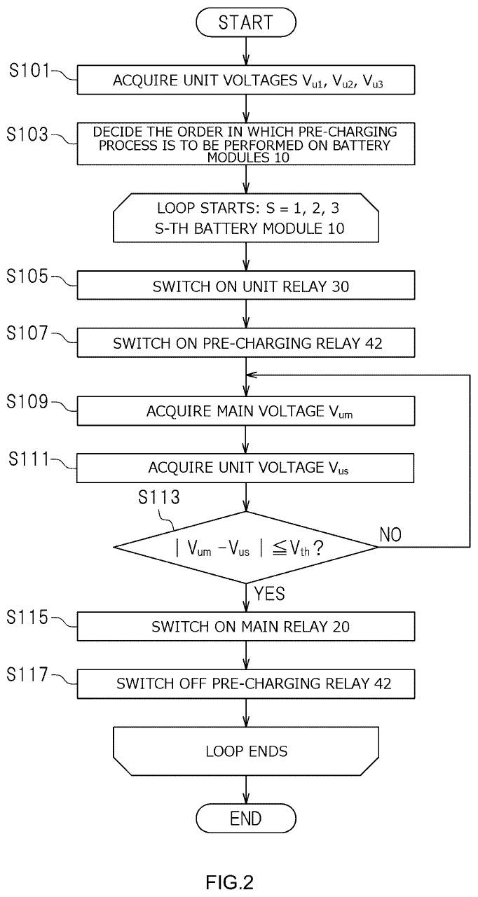

As used herein, the term “pre-charging process” refers to a process to prevent a rush current from flowing to the load 100 by exercising control such that currents are passed through the pre-charging units 40 when the battery units 12 of the battery modules 10 are connected to the load 100 through the pair of output terminals 5. The pre-charging process is able to prevent a rush current from flowing to the load 100 by proactively passing currents through the pre-charging units 40 without passing currents through the main relays 20. In the present embodiment, the pre-charging process involves switching OFF the main relay 20 of a targeted one of the battery modules 10 and switching ON the unit relay 30 and the pre-charging relay 42 of the targeted one of the battery modules 10, and then involves switching ON the main relay 20 of the targeted one of the battery modules 10 and switching OFF the pre-charging relay 42 of the targeted one of the battery modules 10 when a difference between the main voltage carried between the pair of output terminals 5 and the unit voltage across the battery unit 12 of the targeted one of the battery modules 10 is equal to or smaller than a predetermined threshold value Vₜₕ (see FIG. 2). In this embodiment, with the main relay 20, the unit relay 30, and the pre-charging relay 42 of the targeted one of the battery modules 10 each being in an OFF state, the pre-charging process involves switching ON the unit relay 30 of the targeted one of the battery modules 10 and then switching ON the pre-charging relay 42 of the targeted one of the battery modules 10, and involves switching ON the main relay 20 of the targeted one of the battery modules 10 and switching OFF the pre-charging relay 42 of the targeted one of the battery modules 10 after the difference between the main voltage and the unit voltage has become equal to or smaller than the threshold value Vₜₕ.

When the pre-charging process is to be executed by the pre-charging process executor 67, the order decider 65 decides the order in which the pre-charging process is to be performed on the battery modules 10. In this embodiment, the order decider 65 decides the order in which the pre-charging process is to be performed on the battery modules 10 in accordance with the unit voltages across the battery units 12 of the battery modules 10. In this embodiment, the order decider 65 sorts the unit voltages across the battery units 12 of the battery modules 10 (which have been acquired by the unit voltage acquirer 63) in descending order, and decides that the pre-charging process is to be performed on the battery modules 10 in the order in which the unit voltages across the battery units 12 of the battery modules 10 are sorted. The pre-charging process executor 67 executes the pre-charging process on the battery modules 10 in the order decided by the order decider 65.

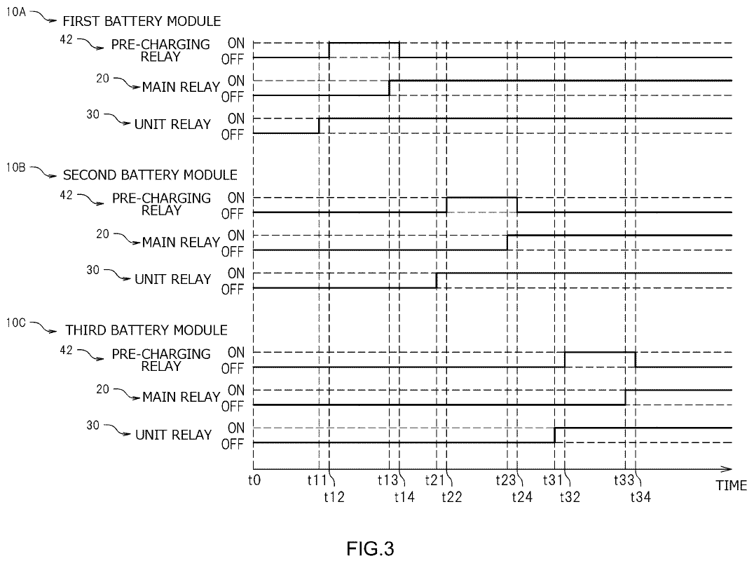

The following description discusses a procedure for performing the pre-charging process on the first to third battery modules 10A to 10C with reference to the flow chart of FIG. 2. Note that 1, 2, and 3 are sequentially substituted for “s” of a unit voltage Vᵤₛ in FIG. 2. Accordingly, the unit voltage Vᵤₛ across the battery unit 12 of the first battery module 10A is represented as a unit voltage Vᵤ₁, the unit voltage Vᵤₛ across the battery unit 12 of the second battery module 10B is represented as a unit voltage Vᵤ₂, and the unit voltage Vᵤₛ across the battery unit 12 of the third battery module 10C is represented as a unit voltage Vᵤ₃. FIG. 3 is a timing chart illustrating the procedure for performing the pre-charging process on the first to third battery modules 10A to 10C. As illustrated in FIG. 3, at a time t₀ preceding the start of the procedure illustrated in the flow chart of FIG. 2, the main relays 20, the unit relays 30, and the pre-charging relays 42 of the first to third battery modules 10A to 10C are each in an OFF state.

In step S101 of FIG. 2, the unit voltage acquirer 63 (see FIG. 1) acquires the unit voltage Vᵤ₁ across the battery unit 12 of the first battery module 10A, the unit voltage Vᵤ₂ across the battery unit 12 of the second battery module 10B, and the unit voltage Vᵤ₃ across the battery unit 12 of the third battery module 10C. In this embodiment, the unit voltage acquirer 63 acquires the unit voltages Vᵤ₁, Vᵤ₂, and Vᵤ₃ from the battery unit voltage detectors 53 of the first battery module 10A, the second battery module 10B, and the third battery module 10C, respectively. The unit voltages Vᵤ₁, Vᵤ₂, and Vᵤ₃ acquired by the unit voltage acquirer 63 are stored in the memory 69 (see FIG. 1).

In step S103 of FIG. 2, the order decider 65 (see FIG. 1) decides the order in which the pre-charging process is to be performed on the first to third battery modules 10A to 10C. In this embodiment, the order decider 65 sorts the unit voltages Vᵤ₁, Vᵤ₂, and Vᵤ₃ (which have been acquired in step S101) in descending order, and decides that the pre-charging process is to be performed on the first to third battery modules 10A to 10C in the order in which the unit voltages Vᵤ₁, Vᵤ₂, and Vᵤ₃ are sorted in descending order. In the present embodiment, the unit voltages Vᵤ₁, Vᵤ₂, and Vᵤ₃ are, for example, in order of decreasing value. In this case, sorting the unit voltages Vᵤ₁, Vᵤ₂, and Vᵤ₃ in descending order results in the pre-charging process being performed on the first battery module 10A, the second battery module 10B, and the third battery module 10C in this order.

The pre-charging process is performed on the first battery module 10A (which is the first one of the battery modules 10) by sequentially performing steps S105 to S117 (see FIG. 2) on the first battery module 10A. As illustrated in FIG. 2, the pre-charging process executor 67 (see FIG. 1) first switches ON the unit relay 30 of the first battery module 10A in step S105, and then switches ON the pre-charging relay 42 of the first battery module 10A in step S107. Referring to FIG. 3, the unit relay 30 of the first battery module 10A is switched ON at a time t11, and the pre-charging relay 42 of the first battery module 10A is switched ON at a time t12. The processes of steps S105 and S107 may be performed in reverse order, which means that the unit relay 30 of the first battery module 10A may be switched ON after the pre-charging relay 42 of the first battery module 10A has been switched ON. Because both of the unit relay 30 and the pre-charging relay 42 of the first battery module 10A are ON at the time t12, passage of a current through the pre-charging unit 40 of the first battery module 10A results in a gradual increase in the unit voltage Vᵤ₁ across the battery unit 12 of the first battery module 10A.

As illustrated in FIG. 2, the main voltage acquirer 61 (see FIG. 1) acquires a main voltage Vᵤₘ in step S109, and the unit voltage acquirer 63 (see FIG. 1) acquires the unit voltage Vᵤ₁ across the battery unit 12 of the first battery module 10A in step S111. In step S113 of FIG. 2, the pre-charging process executor 67 (see FIG. 1) determines whether a difference between the main voltage Vᵤₘ and the unit voltage Vᵤ₁ (which is represented as |Vᵤₘ−Vᵤ₁|) is equal to or smaller than the threshold value Vₜₕ. In this embodiment, the procedure returns to step S109 when the difference between the main voltage Vᵤₘ and the unit voltage Vᵤ₁ is greater than the threshold value Vₜₕ. The procedure proceeds to step S115 when the difference between the main voltage Vᵤₘ and the unit voltage Vᵤ₁ is equal to or smaller than the threshold value Vₜₕ.

The pre-charging process executor 67 (see FIG. 1) switches ON the main relay 20 of the first battery module 10A in step S115, and switches OFF the pre-charging relay 42 of the first battery module 10A in step S117. Referring to FIG. 3, the main relay 20 of the first battery module 10A is switched ON at a time t13, and the pre-charging relay 42 of the first battery module 10A is switched OFF at a time t14. In this embodiment, the pre-charging process is performed on the first battery module 10A during a time period between the time t11 and the time t14.

After the pre-charging process has been performed on the first battery module 10A (which is the first one of the battery modules 10) in the above-described manner, the pre-charging process is performed on the second battery module 10B (which is the second one of the battery modules 10) by sequentially performing steps S105 to S117 (see FIG. 2) on the second battery module 10B. After the pre-charging process on the first battery module 10A has been finished (i.e., after the time t14 in FIG. 3), the pre-charging process executor 67 (see FIG. 1) performs the pre-charging process on the second battery module 10B, with the pre-charging relay 42 of the first battery module 10A being in an OFF state and with the main relay 20 and the unit relay 30 of the first battery module 10A each being in an ON state. The processes of steps S105 to S117 to be performed on the second battery module 10B are substantially the same as the processes of steps S105 to S117 performed on the first battery module 10A, and will thus not be described. Referring to FIG. 3, the unit relay 30 of the second battery module 10B is switched ON at a time t21 (which is later than the time t14), and the pre-charging relay 42 of the second battery module 10B is switched ON at a time t22. Then, the pre-charging process performed on the second battery module 10B results in an increase in the unit voltage Vᵤ₂ during a time period between the time t22 and a time t23, so that the difference between the main voltage Vᵤₘ and the unit voltage Vᵤ₂ becomes equal to or smaller than the threshold value Vₜₕ at the time t23. Accordingly, the main relay 20 of the second battery module 10B is switched ON at the time t23, and the pre-charging relay 42 of the second battery module 10B is switched OFF at a time t24. In this embodiment, the pre-charging process is performed on the second battery module 10B during a time period between the time t21 and the time t24.

After the pre-charging process has been performed on the first battery module 10A (which is the first one of the battery modules 10) and the second battery module 10B (which is the second one of the battery modules 10), the pre-charging process is performed on the third battery module 10C (which is the third one of the battery modules 10) by sequentially performing steps S105 to S117 (see FIG. 2) on the third battery module 10C. In this embodiment, the pre-charging process executor 67 (see FIG. 1) performs the pre-charging process on the third battery module 10C, with the pre-charging relays 42 of the first and second battery modules 10A and 10B each being in an OFF state and with the main relays 20 and the unit relays 30 of the first and second battery modules 10A and 10B each being in an ON state. The processes of steps S105 to S117 to be performed on the third battery module 10C are substantially the same as the processes of steps S105 to S117 performed on the first battery module 10A, and will thus not be described. Referring to FIG. 3, the unit relay 30 of the third battery module 10C is switched ON at a time t31 (which is later than the time t24), and the pre-charging relay 42 of the third battery module 10C is switched ON at a time t32. Then, the pre-charging process performed on the third battery module 10C results in an increase in the unit voltage Vᵤ₃ during a time period between the time t32 and a time t33, so that the difference between the main voltage Vᵤₘ and the unit voltage Vᵤ₃ becomes equal to or smaller than the threshold value Vₜₕ at the time t33. Accordingly, the main relay 20 of the third battery module 10C is switched ON at the time t33, and the pre-charging relay 42 of the third battery module 10C is switched OFF at a time t34. In this embodiment, the pre-charging process is performed on the third battery module 10C during a time period between the time t31 and the time t34. The pre-charging process is performed on the first battery module 10A, the second battery module 10B, and the third battery module 10C separately in sequence as described above, which brings an end to the procedure illustrated in the flow chart of FIG. 2.

As illustrated in FIG. 1, the battery system 1 according to the present embodiment described above includes: the pair of output terminals 5 connected to the load 100; the battery modules 10 connected to the pair of output terminals 5 and disposed in parallel to each other; and the controller 60. Each of the battery modules 10 includes: the battery unit 12 including the cells 11 connected in series to each other; the main relay 20 provided on the first side end portion (which is, in this embodiment, the positive electrode side end portion) of the battery unit 12; the unit relay 30 provided on the second side end portion (which is, in this embodiment, the negative electrode side end portion) of the battery unit 12; and the pre-charging unit 40 provided in parallel to the main relay 20. The pre-charging unit 40 of each of the battery modules 10 includes the pre-resistor 41 and the pre-charging relay 42 connected in series to the pre-resistor 41. The controller 60 includes the pre-charging process executor 67 configured or programmed to, when the battery modules 10 are to be connected to the load 100 through the pair of output terminals 5, exercise control so as to connect the battery modules 10 to the pair of output terminals 5 after having executed the pre-charging process on the battery modules 10 on a one-by-one basis. The pre-charging process involves switching OFF the main relay 20 of a targeted one of the battery modules 10 and switching ON the unit relay 30 and the pre-charging relay 42 of the targeted one of the battery modules 10. The pre-charging process then involves switching ON the main relay 20 of the targeted one of the battery modules 10 and switching OFF the pre-charging relay 42 of the targeted one of the battery modules 10 when a difference between the main voltage carried between the pair of output terminals 5 and the unit voltage across the battery unit 12 of the targeted one of the battery modules 10 is equal to or smaller than the predetermined threshold value Vₜₕ (see FIG. 2).

If the pre-charging relays 42 of the battery modules 10 are switched ON simultaneously, the consumption of current necessary for controlling the pre-charging relays 42 increases temporarily, resulting in great variations in the consumption of current by the controller 60 to control the pre-charging relays 42. Such great variations in current consumption may apply a load to the power supply 70 (see FIG. 1), which supplies electric power to the controller 60, and may lead to variations in voltage across the power supply 70. Thus, great variations in voltage across the power supply 70, which supplies electric power to the controller 60, may cause the battery system 1 to operate unstably. The present embodiment, however, involves performing the pre-charging process on the battery modules 10 sequentially on a one-by-one basis. Accordingly, the present embodiment precludes the pre-charging relays 42 of the battery modules 10 from being switched ON simultaneously, making it possible to stagger the time at which the consumption of current by the controller 60 to control the pre-charging relays 42 of the battery modules 10 increases. Consequently, the present embodiment is able to reduce variations in overall current consumption by the controller 60, making the battery system 1 unlikely to operate unstably.

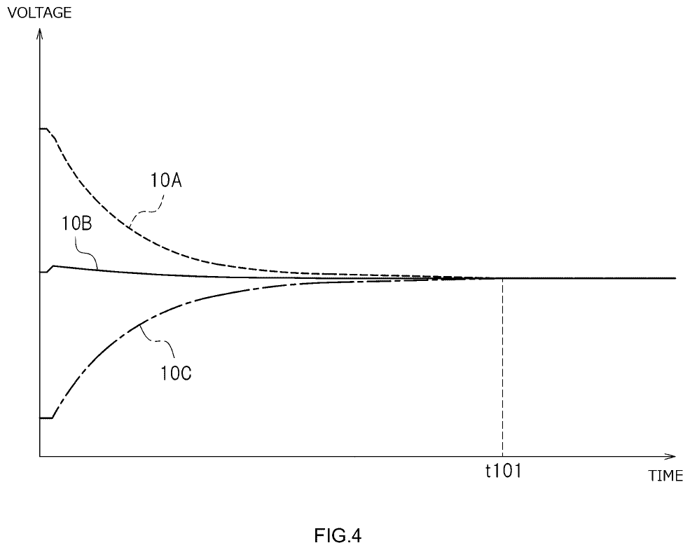

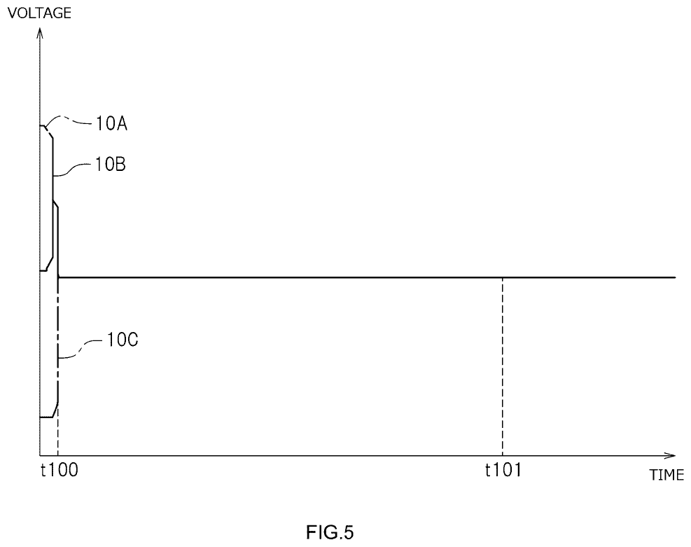

FIG. 4 is a graph illustrating how voltages across the battery modules 10A, 10B, and 10C change with the lapse of time when the pre-charging process is performed on the first to third battery modules 10A to 10C simultaneously such that the pre-charging relays 42 thereof are switched ON simultaneously. FIG. 5 is a graph illustrating how voltages across the battery modules 10A, 10B, and 10C change with the lapse of time when the pre-charging process is performed on the first to third battery modules 10A to 10C sequentially. In each of FIGS. 4 and 5, the horizontal axis represents time, and the vertical axis represents voltage. As illustrated in FIG. 4, if the pre-charging process is performed on the first to third battery modules 10A to 10C simultaneously such that the pre-charging relays 42 thereof are switched ON simultaneously, the voltages across the battery modules 10 are equalized at a time t101. As illustrated in FIG. 5, when the pre-charging process is performed on the first to third battery modules 10A to 10C sequentially as in the present embodiment such that the pre-charging relays 42 thereof are not switched ON simultaneously, the voltages across the battery modules 10A, 10B, and 10C are equalized at a time t100, which precedes the time t101. Accordingly, the present embodiment involves performing the pre-charging process on the battery modules 10 sequentially on a one-by-one basis so as to equalize the voltages across the battery modules 10 in a short time. Because the voltages across the battery modules 10 are equalized in a short time as just described, the present embodiment is able to speed up the startup of the battery system 1.

As illustrated in FIG. 3, with the main relay 20, the unit relay 30, and the pre-charging relay 42 of the targeted one of the battery modules 10 each being in an OFF state, the pre-charging process according to the present embodiment involves switching ON the unit relay 30 of the targeted one of the battery modules 10 and then switching ON the pre-charging relay 42 of the targeted one of the battery modules 10. After the difference between the main voltage and the unit voltage across the battery unit 12 of the targeted one of the battery modules 10 has become equal to or smaller than the threshold value Vₜₕ, the pre-charging process according to the present embodiment involves switching ON the main relay 20 of the targeted one of the battery modules 10 and then switching OFF the pre-charging relay 42 of the targeted one of the battery modules 10. Because the pre-charging process involves switching ON the main relay 20 of the targeted one of the battery modules 10 and then switching OFF the pre-charging relay 42 of the targeted one of the battery modules 10 as just described, the targeted one of the battery modules 10 is connected to the load 100 at all times during the pre-charging process and is thus prevented from being disconnected from the load 100 during the pre-charging process.

As illustrated in FIG. 1, the battery modules 10 in the present embodiment include the first battery module 10A, the second battery module 10B, and the third battery module 10C. As illustrated in FIG. 3, the pre-charging process executor 67 (see FIG. 1) executes the pre-charging process on the first battery module 10A and then executes the pre-charging process on the second battery module 10B after having finished the pre-charging process on the first battery module 10A. The pre-charging process executor 67 subsequently executes the pre-charging process on the third battery module 10C after having finished the pre-charging process on the second battery module 10B. The present embodiment is thus able to perform the pre-charging process on the first to third battery modules 10A to 10C separately with reliability.

After the pre-charging process on the first battery module 10A has been finished (i.e., after the time t14 in FIG. 3), the pre-charging process executor 67 (see FIG. 1) in the present embodiment executes the pre-charging process on the second battery module 10B, with the pre-charging relay 42 of the first battery module 10A being in an OFF state and with the main relay 20 and the unit relay 30 of the first battery module 10A each being in an ON state. After the pre-charging process on the second battery module 10B has been finished (i.e., after the time t24 in FIG. 3), the pre-charging process executor 67 executes the pre-charging process on the third battery module 10C, with the pre-charging relays 42 of the first and second battery modules 10A and 10B each being in an OFF state and with the main relays 20 and the unit relays 30 of the first and second battery modules 10A and 10B each being in an ON state. Accordingly, the present embodiment is able to keep the battery modules 10 connected to the load 100 with reliability after the pre-charging process has been finished.

As illustrated in FIG. 1, the controller 60 in the present embodiment includes the unit voltage acquirer 63 and the order decider 65. In step S101 of FIG. 2, the unit voltage acquirer 63 acquires the unit voltages across the battery units 12 of the battery modules 10. In step S103 of FIG. 2, the order decider 65 sorts the unit voltages across the battery units 12 of the battery modules 10 (which have been acquired by the unit voltage acquirer 63) in descending order, and decides that the pre-charging process is to be performed on the battery modules 10 sequentially in the order in which the unit voltages across the battery units 12 of the battery modules 10 are sorted. The pre-charging process executor 67 (see FIG. 1) executes the pre-charging process on the battery modules 10 sequentially in the order decided by the order decider 65. Because the pre-charging process is performed on the battery modules 10 sequentially in descending order of unit voltage as just described, the present embodiment is able to reduce the difference between the main voltage across the battery modules 10 and the unit voltage across the battery unit 12 of each battery module 10. Consequently, the present embodiment is able to prevent or reduce an overcurrent that may be generated by the pre-charging process.

Alternatively, the order decider 65 may sort the unit voltages across the battery units 12 of the battery modules 10 in ascending order and may decide that the pre-charging process is to be performed on the battery modules 10 sequentially in the order in which the unit voltages across the battery units 12 of the battery modules 10 are sorted. Such an alternative is also able to reduce the difference between the main voltage across the battery modules 10 and the unit voltage across the battery unit 12 of each battery module 10, making it possible to prevent or reduce occurrence of an overcurrent.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1:

A battery system comprising:
a pair of output terminals connected to a load;
battery modules connected to the pair of output terminals and disposed in parallel to each other; and
a controller, wherein
each of the battery modules includes
   a battery unit including cells connected in series to each other,
   a main relay provided on a first side end portion of the battery unit,
   a unit relay provided on a second side end portion of the battery unit, and
   a pre-charging unit provided in parallel to the main relay,
the pre-charging unit of each of the battery modules includes
   a pre-resistor, and
   a pre-charging relay connected in series to the pre-resistor,
the controller includes a pre-charging process executor configured or programmed to, when the battery modules are to be connected to the load through the pair of output terminals, exercise control so as to connect the battery modules to the pair of output terminals after having executed a pre-charging process on the battery modules on a one-by-one basis, and
the pre-charging process involves switching OFF the main relay of a targeted one of the battery modules and switching ON the unit relay and the pre-charging relay of the targeted one of the battery modules, and the pre-charging process then involves switching ON the main relay of the targeted one of the battery modules and switching OFF the pre-charging relay of the targeted one of the battery modules when a difference between a main voltage carried between the pair of output terminals and a unit voltage across the battery unit of the targeted one of the battery modules is equal to or smaller than a predetermined threshold value.

### Item 2:

The battery system according to item 1, wherein
with the main relay, the unit relay, and the pre-charging relay of the targeted one of the battery modules each being in an OFF state, the pre-charging process involves switching ON the unit relay of the targeted one of the battery modules and then switching ON the pre-charging relay of the targeted one of the battery modules, and
after the difference between the main voltage and the unit voltage has become equal to or smaller than the threshold value, the pre-charging process involves switching ON the main relay of the targeted one of the battery modules and then switching OFF the pre-charging relay of the targeted one of the battery modules.

### Item 3:

The battery system according to item 1 or 2, wherein
the battery modules include a first battery module and a second battery module, and
the pre-charging process executor executes the pre-charging process on the first battery module and then executes the pre-charging process on the second battery module after having finished the pre-charging process on the first battery module.

### Item 4:

The battery system according to item 3, wherein
after the pre-charging process on the first battery module has been finished, the pre-charging process executor executes the pre-charging process on the second battery module, with the pre-charging relay of the first battery module being in an OFF state and with the main relay and the unit relay of the first battery module each being in an ON state.

### Item 5:

The battery system according to any one of items 1 to 4, wherein
the controller includes
   a unit voltage acquirer to acquire the unit voltages across the battery units of the battery modules, and
   an order decider to sort the unit voltages across the battery units of the battery modules, which have been acquired by the unit voltage acquirer, in ascending order or in descending order, and decide that the pre-charging process is to be performed on the battery modules sequentially in the order in which the unit voltages across the battery units of the battery modules are sorted, and
the pre-charging process executor executes the pre-charging process on the battery modules sequentially in the order decided by the order decider.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A battery system comprising:
a pair of output terminals connected to a load;
battery modules connected to the pair of output terminals and disposed in parallel to each other; and
a controller, wherein
each of the battery modules includes
a battery unit including cells connected in series to each other,
a main relay provided on a first side end portion of the battery unit,
a unit relay provided on a second side end portion of the battery unit, and
a pre-charging unit provided in parallel to the main relay,
the pre-charging unit of each of the battery modules includes
a pre-resistor, and
a pre-charging relay connected in series to the pre-resistor,
the controller includes a pre-charging process executor configured or programmed to, when the battery modules are to be connected to the load through the pair of output terminals, exercise control so as to connect the battery modules to the pair of output terminals after having executed a pre-charging process on the battery modules on a one-by-one basis, and
the pre-charging process involves switching OFF the main relay of a targeted one of the battery modules and switching ON the unit relay and the pre-charging relay of the targeted one of the battery modules, and the pre-charging process then involves switching ON the main relay of the targeted one of the battery modules and switching OFF the pre-charging relay of the targeted one of the battery modules when a difference between a main voltage carried between the pair of output terminals and a unit voltage across the battery unit of the targeted one of the battery modules is equal to or smaller than a predetermined threshold value.

2. The battery system according to claim 1, wherein
with the main relay, the unit relay, and the pre-charging relay of the targeted one of the battery modules each being in an OFF state, the pre-charging process involves switching ON the unit relay of the targeted one of the battery modules and then switching ON the pre-charging relay of the targeted one of the battery modules, and
after the difference between the main voltage and the unit voltage has become equal to or smaller than the threshold value, the pre-charging process involves switching ON the main relay of the targeted one of the battery modules and then switching OFF the pre-charging relay of the targeted one of the battery modules.

3. The battery system according to claim 1, wherein
the battery modules include a first battery module and a second battery module, and
the pre-charging process executor executes the pre-charging process on the first battery module and then executes the pre-charging process on the second battery module after having finished the pre-charging process on the first battery module.

4. The battery system according to claim 3, wherein
after the pre-charging process on the first battery module has been finished, the pre-charging process executor executes the pre-charging process on the second battery module, with the pre-charging relay of the first battery module being in an OFF state and with the main relay and the unit relay of the first battery module each being in an ON state.

5. The battery system according to claim 1, wherein
the controller includes
a unit voltage acquirer to acquire the unit voltages across the battery units of the battery modules, and
an order decider to sort the unit voltages across the battery units of the battery modules, which have been acquired by the unit voltage acquirer, in ascending order or in descending order, and decide that the pre-charging process is to be performed on the battery modules sequentially in the order in which the unit voltages across the battery units of the battery modules are sorted, and
the pre-charging process executor executes the pre-charging process on the battery modules sequentially in the order decided by the order decider.
